(19) United States
(12) Patent Application Publication
(10) Pub. No.: US 2008/0150458 A1
(43) Pub. Date: Jun. 26, 2008

(54) Adjustable brake device

(75) Inventors: Matti Ryynanen, Espoo (FI); Joonas Ryynanen, Espoo (FI); Tessa Ryynanen, Helsinki (FI); Ilpo Kauhaniemi, Vantaa (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/645,211

(22) Filed: Dec. 22, 2006

(51) Int. Cl. F16F 15/03

(52) U.S. Cl. 318/362; 188/267

(57) ABSTRACT

The invention relates to an adjustable brake device that can be used in conjunction with a hinge mechanism of a folding electronic device, e.g. a clamshell mobile phone. The adjustable brake device comprises a brake actuator that is able to generate a braking force responsive to a magnetic flux directed to the brake actuator and a magnetic circuit that has a magnetizing device arranged to generate the magnetic flux and a magnetic path arranged to conduct the magnetic flux from the magnetizing device to the brake actuator. At least two elements of the magnetic circuit are movable with respect to each other. A mutual position of the at least two elements can be used for determining strength of the magnetic flux directed to the brake actuator. The braking force can be adjusted in a relatively simple way by adjusting the mutual position of the movable parts of the magnetic circuit.

### FIELD OF THE INVENTION

The invention relates to a method for adjusting damping of movement of hinged parts of a folding electronic device. Furthermore, the invention relates to an adjustable brake device, to a hinge mechanism, and to a folding electronic device.

### BACKGROUND

A folding electronic device, e.g. a clamshell mobile phone, comprises parts that are mechanically connected to each other with the aid of a hinge mechanism. For example, a folding communication device can comprise a flip cover that is hinged to a main body of the folding communication device. Opening of a folding electronic device having a spring-activated hinge that has no damping mechanism causes unwanted inertia forces when parts that are turning with respect to each other reach their open position and an end stopper of the hinge mechanism abruptly stops the movement. Furthermore, the opening speed depends on a posture of the folding electronic device, because in certain postures the gravity force tends to accelerate the opening whereas in certain other postures the gravity force tends to inhibit the opening. Therefore, the work that has to be done by the spring for opening a folding electronic device depends on the posture in which a user holds the folding electronic device. Stiffness of the spring should to be selected in such a way that the spring is able to open the folding electronic device and, on the other hand, the above-described inertia forces are within allowed limits in any posture. In order to avoid disturbing inertia forces when the folding electronic device reaches its open position, the opening speed should be reduced smoothly before the end stopper. Arranging satisfactory opening speed profiles for different postures is an especially challenging task when a part that has to be moved during opening, e.g. a flip cover, is heavy. This kind of case is present, for example, when the part to be moved contains a significant amount of electronics. Because of different usage situations and customary habits of users, a hinge mechanism of a folding electronic device should be provided with an adjustable brake/damping arrangement.

A solution according to the prior art is to provide a hinge mechanism with a mechanical friction damper that produces a friction force that starts to increase when the hinge mechanism reaches a pre-determined position during opening. In principle, a friction force generated by a mechanical friction damper could be adjusted e.g. by adjusting a normal force between surfaces between which the friction force is present. This kind of solution would, however, require a mechanical arrangement for adjusting the above-mentioned normal force. Such mechanical arrangements are usually expensive and complex. Furthermore, a typical feature of many adjustable mechanical friction dampers is the fact that a significant force and/or amount of energy are/is needed for adjusting an opening speed profile of the hinge mechanism.

Another solution according to the prior art is to provide a hinge mechanism with a viscous damper having a substantially constant damping coefficient. Damping force generated by a viscous damper having a substantially constant damping coefficient is proportional to opening speed of the hinge mechanism. In principle, a damping coefficient of a viscous damper could be adjusted e.g. by adjusting the amount of damper fluid that is arranged to create the damping action. This kind of solution would, however, require pump and valve arrangements for controlling the amount of damper fluid. Such pump and valve arrangements are usually expensive and mechanically complex.

### SUMMARY

An objective of the present invention is to provide an adjustable brake device that can be used for providing an improved hinge mechanism for a folding electronic device. A further objective of the present invention is to provide a hinge mechanism that can be used in conjunction with a folding electronic device. A further objective of the present invention is to provide a folding electronic device. A further objective of the present invention is to provide a method for adjusting damping of turning movement of hinged parts of a folding electronic device.

In accordance with a first aspect of the invention an adjustable brake device is provided. The adjustable brake device comprises:
a brake actuator arranged to generate a braking force responsive to a magnetic flux directed to said brake actuator, and
a magnetic circuit arranged to generate said magnetic flux and arranged to conduct said magnetic flux to said brake actuator,
   wherein a first element of said magnetic circuit is movable with respect to a second element of said magnetic circuit and a mutual position of said first element and said second element is arranged to at least partly determine strength of said magnetic flux.

In accordance with a second aspect of the invention a hinge mechanism is provided. The hinge mechanism comprises:
a first part and a second part that are able to turn with respect to each other,
a brake actuator arranged to generate a braking force responsive to a magnetic flux directed to said brake actuator, said braking force being able to damp turning movement of said first part with respect to said second part, and
a magnetic circuit arranged to generate said magnetic flux and arranged to conduct said magnetic flux to said brake actuator,
   wherein a first element of said magnetic circuit is movable with respect to a second element of said magnetic circuit and a mutual position of said first element and said second element is arranged to at least partly determine strength of said magnetic flux.

In accordance with a third aspect of the invention a folding electronic device having a first part and a second part hinged to each other is provided. The folding electronic device comprises:
a brake actuator arranged to generate a braking force responsive to a magnetic flux directed to said brake actuator, said braking force being able to damp turning movement of the first part with respect to the second part, and
a magnetic circuit arranged to generate said magnetic flux and arranged to conduct said magnetic flux to said brake actuator,
   wherein a first element of said magnetic circuit is movable with respect to a second element of said magnetic circuit and a mutual position of said first element and said second element is arranged to at least partly determine strength of said magnetic flux.

In accordance with a fourth aspect of the invention a method is provided for adjusting damping of turning movement of hinged parts of a folding electronic device. The method comprises:
generating a magnetic flux,
generating a braking force responsive to said magnetic flux, said braking force being able to damp turning movement of the hinged parts of the folding electronic device, and
adjusting strength of said magnetic flux by adjusting a mutual position of a first element and a second element of a magnetic circuit.

A number of embodiments of the invention are described in accompanied dependent claims.

The benefit provided by embodiments of the present invention when compared with prior art solutions of the kind described above is that braking force generated by a brake device according to an embodiment of the invention can be adjusted in a relatively simple way by adjusting a mutual position of movable parts of a magnetic circuit of the brake device. Furthermore, the magnetic circuit can be designed in such a way that the total magnetic flux generated in the magnetic circuit is substantially constant or subject to only small changes when the mutual position of the movable parts of the magnetic circuit is varied. In this kind of case, the magnetic energy stored in the magnetic circuit is substantially constant or subject to only small changes and, therefore, only a small force and/or amount of energy are/is needed for adjusting the brake device.

Various embodiments of the invention both as to constructions and to methods of operation, together with additional objects and advantages thereof, will be best understood from the following description of specific embodiments when read in connection with the accompanying drawings.

The embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### BRIEF DESCRIPTION OF THE FIGURES

The invention and its advantages are explained in greater detail below with reference to the embodiments presented in the sense of examples and with reference to the accompanying drawings, in which

FIGS. 1a, 1b, 1c, 1d and 1e show side section views and cross section views of an adjustable brake device according to an embodiment of the invention,

FIGS. 1f and 1g show a side section view and a cross section view of an adjustable brake device according to an embodiment of the invention,

FIGS. 2a, 2b, and 2c show a side section view and cross section views of an adjustable brake device according to an embodiment of the invention,

FIGS. 3a, 3b, 3c, and 3d show side section views and cross section views of an adjustable brake device according to an embodiment of the invention,

FIGS. 4a and 4b show side section views of an adjustable brake device according to an embodiment of the invention,

FIGS. 5a, 5b, and 5c show side section views and a cross section view of an adjustable brake device according to an embodiment of the invention,

FIGS. 6a and 6b show a side section view and a cross section view of an adjustable brake device according to an embodiment of the invention,

FIGS. 7a and 7b show a side view and a butt-end view of a hinge mechanism according to an embodiment of the invention,

FIG. 8 shows a folding electronic device according to an embodiment of the invention, and

FIG. 9 is a flow chart of a method according to an embodiment of the invention for adjusting damping of turning movement of hinged elements of a folding electronic device.

### DETAILED DESCRIPTION OF THE EMBODIMENTS

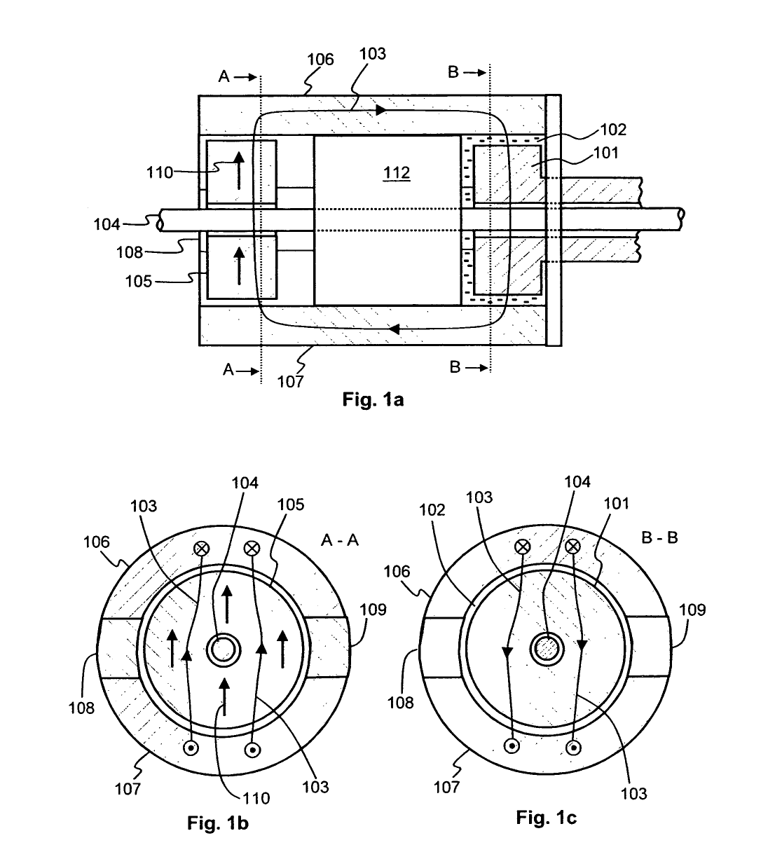

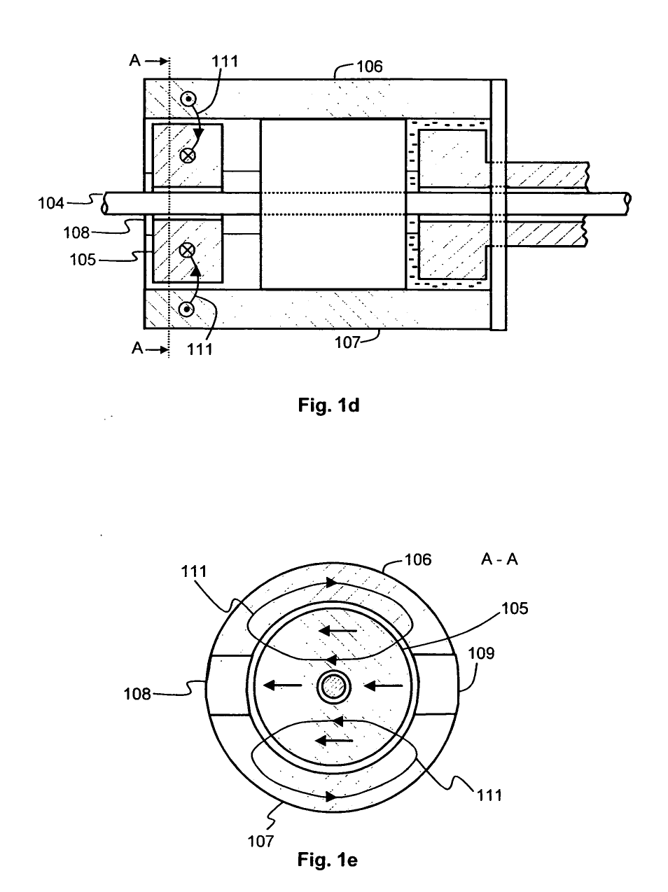

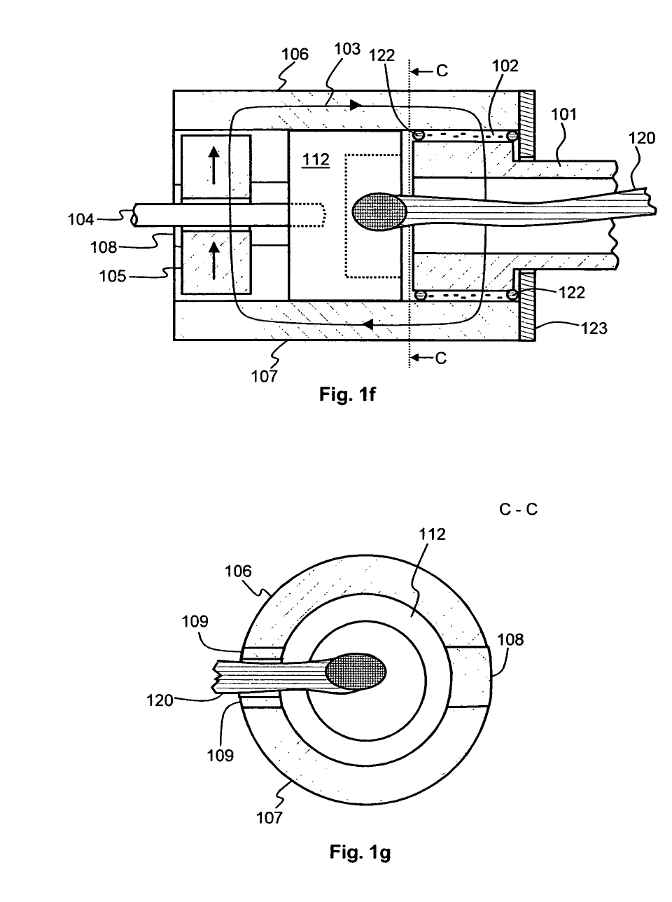

FIG. 1a shows a side section view of an adjustable brake device-according to an embodiment of the invention. FIG. 1b shows a cross section A-A of the adjustable brake device and FIG. 1c shows a cross section B-B of the adjustable brake device. Hatched areas in the figures correspond with cut surfaces. The adjustable brake device comprises a brake actuator that is arranged to generate a braking force responsive to a magnetic flux directed to the brake actuator. In this embodiment of the invention the brake actuator comprises a brake wheel 101 that is surrounded by fluid 102 that can be ferrofluid or magnetorheological fluid (MRF). Ferrofluid can be composed of small polar magnetite Fe₃O₄ particles surrounded by a surfactant and suspended in a nonpolar liquid medium. Tiny particles of magnetite are suspended throughout liquid medium. In order to prevent the particles from aggregating, they can be surrounded by a polar end of long chain fatty acid molecules, to which the particles are attracted by ion-dipole forces. The long, nonpolar tails of the molecules are attracted by London forces to the molecules of the oil that serves as the liquid medium, but cannot compete with the polar ends in their attraction for the particles. Magnetorheological fluid can be composed of carbonyl iron powder in a carrier liquid like conventional mineral oil.

The viscosity/stiffness of the ferrofluid or the magnetorheological fluid is responsive to a magnetic flux 103. The stiffness/viscosity of the ferrofluid or the magnetorheological fluid can be adjusted by adjusting strength of the magnetic flux 103. The stiffness/viscosity of the ferrofluid or the magnetorheological fluid causes a braking force on a surface of the brake wheel 101 as a response to a situation in which the surface moves with respect to the ferrofluid or the magnetorheological fluid, i.e. the brake wheel rotates around an axis 104.

The adjustable brake device comprises a magnetic circuit arranged to generate the magnetic flux 103 and to conduct the magnetic flux 103 to the brake actuator. The magnetic circuit comprises a magnetizing device 105 that is arranged to generate the magnetic flux 103 and a magnetic path that is arranged to conduct the magnetic flux 103 from the magnetizing device 105 to the brake actuator. Parts 106 and 107 of the brake device act as portions of the magnetic path via which the magnetic flux 103 flows between the magnetizing device 105 and the brake actuator. The parts 106 and 107 and the brake wheel 101 can be made of ferromagnetic material like iron. The parts 106 and 107 are separated from each other with parts 108 and 109 that are made of material having a smaller relative permeability μᵣ than that of the parts 106 and 107. The parts 108 and 109 can be made of e.g. plastic.

The axis 104 is supported with the aid of an axis supporting part 112 that is made of material having a smaller relative permeability μᵣ than that of the parts 106 and 107. The axis supporting part 112 can be made of e.g. plastic.

In this embodiment of the invention the magnetizing device 105 is a permanent magnet that has a cylindrical shape. A magnetizing direction 110 of the permanent magnet is perpendicular to the axis 104. In an alternative embodiment of the invention the magnetizing device 105 can be an electrical magnet that comprises a coil of electrical conductor for carrying magnetizing electrical current and a current source for generating the magnetizing electrical current.

A first element of the magnetic circuit and a second element of the magnetic circuit are movable with respect to each other and a mutual position of the first and second elements is arranged to at least partly determine strength of the magnetic flux 103. In this embodiment of the invention the permanent magnet 105 represents the first element that is movable with respect to the second element that consists of parts 106,107,108, and 109.

The strength of said magnetic flux 103 can be adjusted by rotating the permanent magnet 105 around the axis 104. FIGS. 1a, 1b, and 1c illustrate a situation in which the magnetic flux 103 directed to the brake actuator has its maximum strength. FIGS. 1d and 1e illustrate a situation in which the magnetic flux directed to the brake actuator has its minimum strength. The reference numbers in FIGS. 1d and 1e corresponds with those in FIGS. 1a, 1b, and 1c. In the situation illustrated in FIGS. 1d and 1e, the permanent magnet 105 has been rotated by ninety degrees (90°) with respect to the situation illustrated in FIGS. 1a, 1b, and 1c. In FIGS. 1d and 1e, a main portion of the total magnetic flux generated by the permanent magnet 105 bypasses the brake actuator. The parts 106 and 107 form a bypass path for a magnetic flux 111 that bypasses the brake actuator as illustrated in FIGS. 1d and 1e. The strength of the magnetic flux 103 can be adjusted in a stepless way by adjusting a rotation angle of the permanent magnet 105 between the two extremes shown in FIGS. 1a-1e.

FIG. 1f shows a side section view of an adjustable brake device according to an embodiment of the invention. FIG. 1g shows a cross section C-C of the adjustable brake device. Hatched areas in the figures correspond with cut surfaces. The adjustable brake device comprises a brake actuator that is arranged to generate a braking force responsive to a magnetic flux directed to the brake actuator. In this embodiment of the invention the brake actuator comprises a brake wheel 101 that is surrounded by fluid 102 that can be ferrofluid or magnetorheological fluid (MRF).

The adjustable brake device comprises a magnetic circuit arranged to generate a magnetic flux 103 and to conduct the magnetic flux 103 to the brake actuator. The magnetic circuit comprises a permanent magnet 105 that is arranged to generate the magnetic flux 103 and a magnetic path that is arranged to conduct the magnetic flux 103 from the permanent magnet 105 to the brake actuator. Parts 106 and 107 of the brake device act as portions of the magnetic path via which the magnetic flux 103 flows between the permanent magnet 105 and the brake actuator. The parts 106 and 107 and the brake wheel 101 can be made of ferromagnetic material like iron. The parts 106 and 107 are separated from each other with parts 108 and 109 that are made of material having a smaller relative permeability μᵣ than that of the parts 106 and 107. The parts 108 and 109 can be made of e.g. plastic. The strength of said magnetic flux 103 can be adjusted by rotating the permanent magnet 105 around an axis 104. The axis 104 is supported with the aid of an axis supporting part 112 that is made of material having a smaller relative permeability P than that of the parts 106 and 107. The axis supporting part 112 can be made of e.g. plastic. Seal elements 122 prevent the ferrofluid or the magnetorheological fluid from leaking out from gaps between the brake wheel 101 and the parts 106, 107, 108, and 109. The brake wheel 101 is able to rotate in an aperture of an end plate 123. The brake wheel is hollow in such a way that a cable 120 can go through the adjustable brake device. A route of the cable 120 is arranged to go through the hollow brake wheel and an aperture in the part 109 as shown in FIGS. 1f and 1g.

The adjustable brake device shown in FIGS. 1f and 1g can be used, for example, in a folding electronic device. A route of an electrical cable between hinged parts of the folding electronic device can be arranged to go through a hollow brake wheel in a similar manner as the route of the cable 120 in the adjustable brake device shown in FIGS. 1f and 1g.

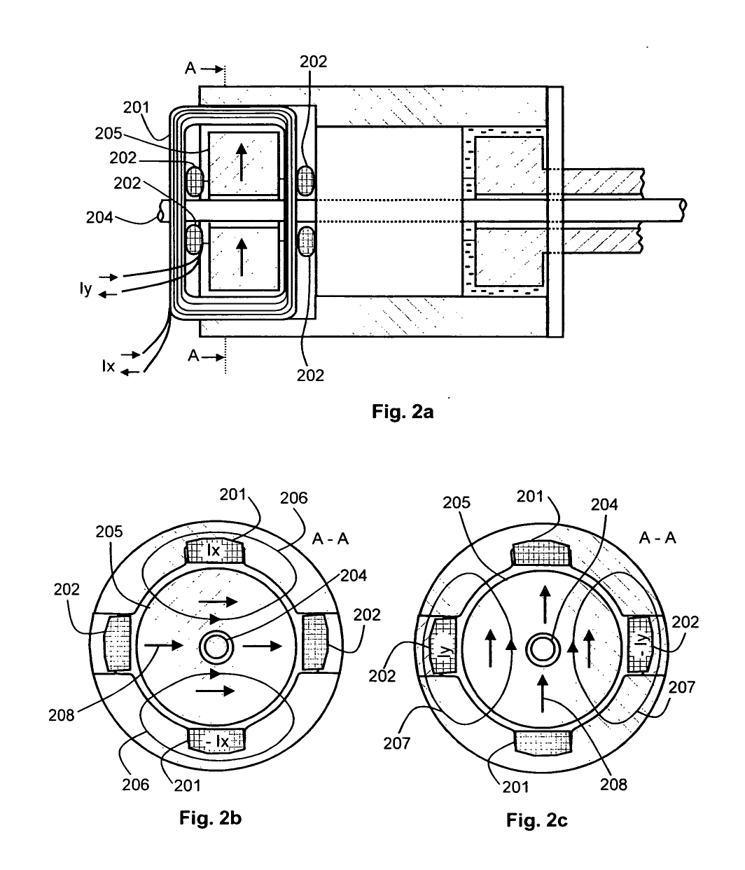

FIG. 2a shows a side section view of an adjustable brake device according to an embodiment of the invention. The brake device comprises an X-coil 201 and an Y-coil 202 that are arranged to carry electrical currents Ix and Iy for producing a magnetic flux that tends to rotate a permanent magnet 205 around an axis 204. FIGS. 2b and 2c show a cross section A-A of the brake device. Hatched areas in the figures correspond with cut surfaces. FIG. 2b illustrates a situation in which the electrical current Ix is flowing and the electrical current Iy is zero. The electrical current Ix generates a magnetic flux 206 that tends to rotate the permanent magnet to the position shown in FIG. 2b. FIG. 2c illustrates a situation in which the electrical current Iy is flowing and the electrical current Ix is zero. The electrical current Iy generates a magnetic flux 207 that tends to rotate the permanent magnet to the position shown in FIG. 2c. Arrow 208 illustrates the magnetizing direction of the permanent magnet 205. The permanent magnet 205 can be set into different rotation angles by selecting suitable values for Ix and Iy. For example, if Ix and Iy have such values that the magnetic fluxes 206 and 207 have equal strengths the combined effect of the magnetic fluxes 206 and 207 tends to set the permanent magnet into a rotation angle that is 45 degrees counter-clockwise from the rotation angle shown in FIG. 2b.

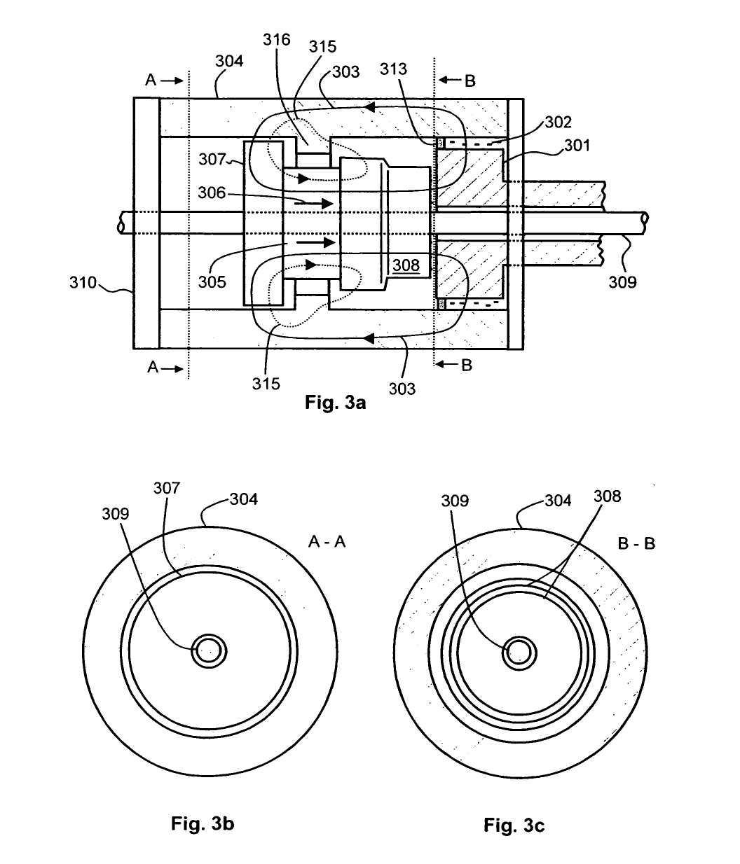

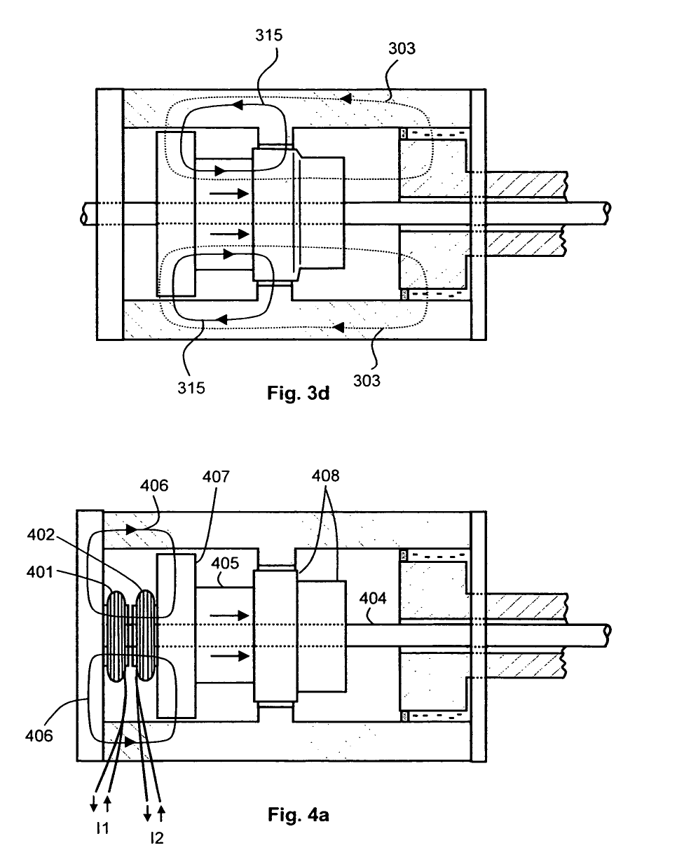

FIG. 3a shows a side section view of an adjustable brake device according to an embodiment of the invention. FIG. 3b shows a cross section A-A of the adjustable brake device and FIG. 3c shows a cross section B-B of the adjustable brake device. Hatched areas in the figures correspond with cut surfaces. The adjustable brake device comprises a brake actuator that is arranged to generate a braking force responsive to a magnetic flux directed to the brake actuator. In this embodiment of the invention the brake actuator comprises a brake wheel 301 that is surrounded by fluid 302 that can be ferrofluid or magnetorheological fluid (MRF). A seal element 313 prevents the ferrofluid or the magnetorheological fluid from leaking out from a gap between the brake wheel 301 and a part 304. The brake wheel 301 is able to rotate around an axis 309 that is supported with the aid of an axis supporting part 310.

The adjustable brake device comprises a magnetic circuit having a magnetizing device 305 that is arranged to generate a magnetic flux 303 and a magnetic path that is arranged to conduct the magnetic flux 303 from the magnetizing device 305 to the brake actuator. In this embodiment of the invention the magnetizing device 305 is a permanent magnet that has a cylindrical shape. A magnetizing direction 306 of the permanent magnet is parallel with the axis 309.

The permanent magnet 305 and parts 307 and 308 form a movable element that can be moved along the axis 309. The parts 307, 308, and 304 act as portions of the magnetic path via which the magnetic flux 303 flows between the permanent magnet 305 and the brake actuator. The parts 307, 308, and 304 and the brake wheel 301 can be made of ferromagnetic material like iron.

A first element of the magnetic circuit and a second element of the magnetic circuit are movable with respect to each other and a mutual position of the first and second elements is arranged to at least partly determine strength of the magnetic flux 303. In this embodiment of the invention the movable element consisting of the permanent magnet 305 and of the parts 307 and 308 represents the first element that is movable with respect to the part 304 that represents the second element. The strength of the magnetic flux 303 is adjusted by adjusting the position of the movable element 305, 307, 308 on the axis 309.

The magnetic circuit comprises a bypass magnetic path that conducts another magnetic flux 315 that is generated by the permanent magnet 305 to bypass the brake actuator. A change in the mutual position between the movable element 305, 307, 308 and the part 304 is arranged to increase the magnetic flux 315 as a response to a situation in which the named change causes a decrease in the magnetic flux 303. The above-mentioned effect is achieved with an overhang 316. When the movable element 305, 307, 308 is moved towards the axis supporting part 310, the part 308 gets closer to the overhang and, therefore, the reluctance of the bypass magnetic path carrying the magnetic flux 315 decreases and the magnetic flux 315 increases. On the other hand, the part 308 gets farther from the brake wheel 301 and, therefore, the reluctance of the magnetic path carrying the magnetic flux 303 increases and the magnetic flux 303 decreases.

FIG. 3a illustrates a situation in which the magnetic flux 303 has its maximum strength. FIG. 3d illustrates a situation in which the magnetic flux 303 has its minimum strength and the magnetic flux 315 has its maximum strength.

A shape of the part 308 and a shape of the overhang 316 can be designed in such a way that the total magnetic flux generated by the permanent magnet 305 is substantially constant or subject to only small changes when the position of the movable element 305, 307, 308 is varied. In this kind of case, the magnetic energy stored in the magnetic circuit is substantially constant or subject to only small changes and, therefore, only a small force and/or amount of energy are/is needed for changing the position of the movable element 305, 307, 308. I.e. only a small force and/or amount of energy are/is needed for adjusting the brake device. Suitable shapes for the part 308 and for the overhang 316 can be found with prototype testing and/or with simulations. For example, numerical field calculation based on a finite element method (FEM) can be used in simulations.

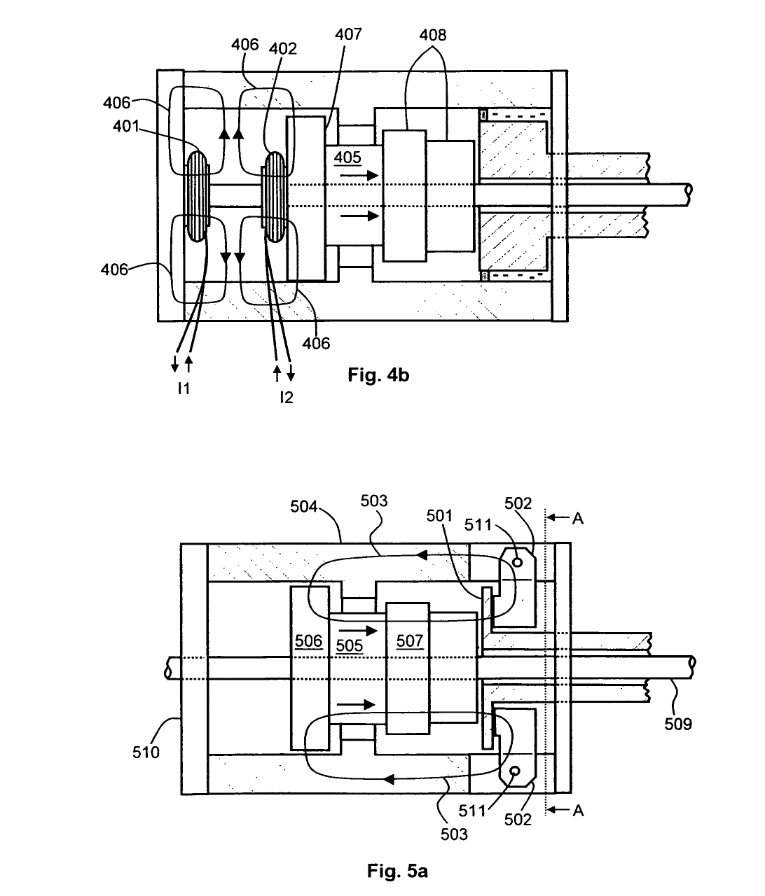

FIGS. 4a and 4b show side section views of an adjustable brake device according to an embodiment of the invention. The brake device comprises coils 401 and 402 that are arranged to carry electrical currents I1 and I2 for producing magnetic fluxes that tend to move a movable element 405, 407, 408 along an axis 404. FIG. 4a illustrates a situation in which the electrical currents I1 and I2 magnetize in a same direction when there is an attractive force between the coils 401 and 402. FIG. 4b illustrates a situation in which the electrical currents I1 and I2 magnetize in opposite directions when there is a repulsive force between the coils 401 and 402. Closed curves 406 represent magnetic fluxes produced by the electrical currents I1 and I2.

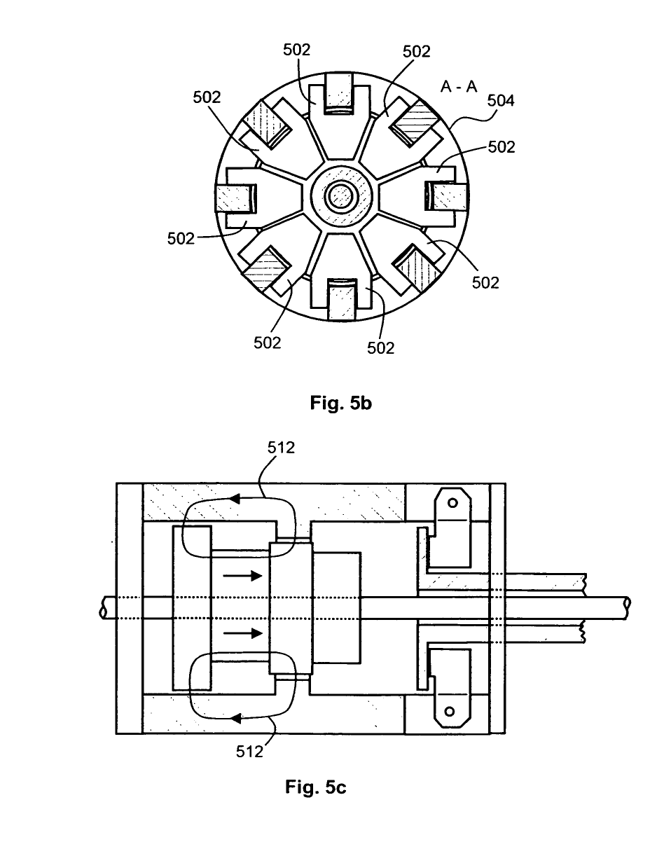

FIG. 5a shows a side section view of an adjustable brake device according to an embodiment of the invention. FIG. 5b shows a cross section A-A of the brake device. Hatched areas in the figures correspond with cut surfaces. The adjustable brake device comprises a brake actuator that is arranged to generate a braking force responsive to a magnetic flux directed to the brake actuator. In this embodiment of the invention the brake actuator is a disk brake comprising a brake disk 501 and brake pads 502. The brake disk 501 is able to rotate around an axis 509 that is supported with the aid of an axis supporting part 510. The brake pads 502 are made of material having a greater relative permeability μᵣ than that of air. The brake pads 502 can be made of e.g. iron. The brake pads are moveably pivoted to a part 504 with the aid of pins 511. Therefore, the brake pads are pressed against the brake disk when a magnetic flux 503 flows via the brake pads.

A permanent magnet 505 and parts 506 and 507 form a movable element that can be moved along the axis 509. Strength of the magnetic flux 503 can be adjusted by adjusting a position of the movable element on the axis 509. The parts 504, 506, and 507 can be made of e.g. iron. FIG. 5a illustrates a situation in which the magnetic flux 503 directed to the brake actuator has its maximum strength. FIG. 5c illustrates a situation in which the magnetic flux directed to the brake actuator has its minimum strength. Closed curves 512 in FIG. 5b represent a magnetic flux that bypasses the brake actuator.

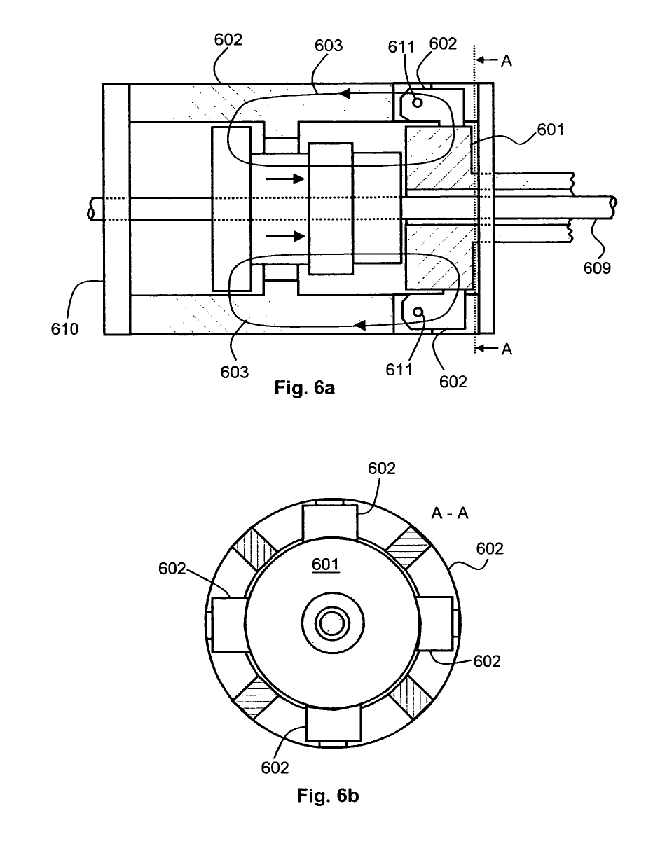

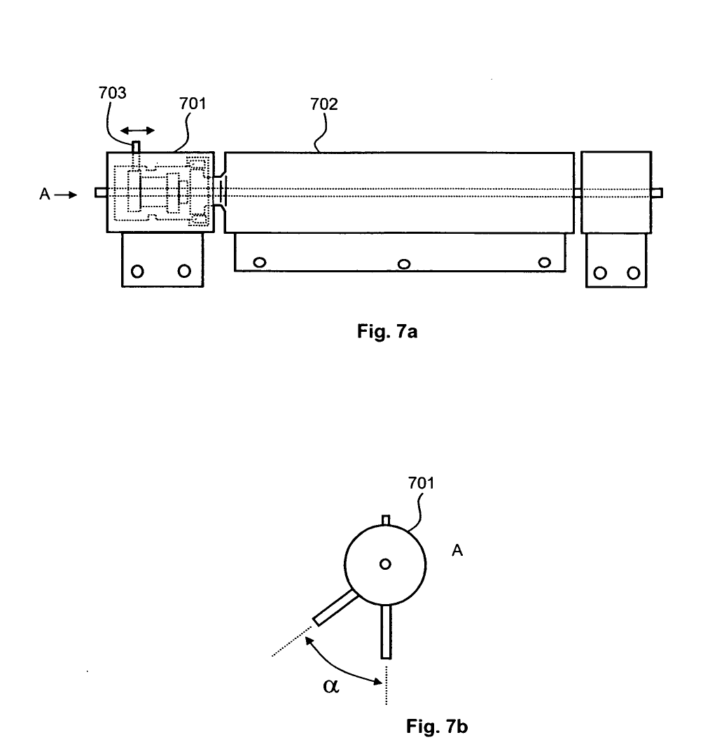

FIG. 6a shows a side section view of an adjustable brake device according to an embodiment of the invention. FIG. 6b shows a cross section A-A of the brake device. Hatched areas in the figures correspond with cut surfaces. The adjustable brake device comprises a brake actuator that is arranged to generate a braking force responsive to a magnetic flux directed to the brake actuator. In this embodiment of the invention the brake actuator is a drum brake having external brake shoes. The brake actuator comprises a brake drum 601 and brake shoes 602. The brake drum 601 is able to rotate around an axis 609 that is supported with the aid of an axis supporting part 610. The brake shoes 602 are made of material having a greater relative permeability μᵣ than that of air. The brake drum 601 and the brake shoes 602 can be made of e.g. iron. The brake shoes are moveably pivoted to a part 604 with the aid of pins 611. Therefore, the brake shoes are pressed against the brake drum when a magnetic flux 603 flows via the brake shoes. FIGS. 7a shows a side view of a hinge mechanism according to an embodiment of the invention. FIG. 7b shows a butt-end view A of the hinge mechanism. The hinge mechanism comprises a first part 701 and a second part 702 that are able to turn with respect to each other. The first part 701 comprises a brake actuator arranged to generate a braking force responsive to a magnetic flux directed to the brake actuator. The braking force is able to damp turning movement of said first part with respect to said second part. The turning movement represents variation of angle α shown in FIG. 7b. The first part 701 comprises a magnetic circuit arranged to generate the magnetic flux and to conduct the magnetic flux to the brake actuator. A first element and a second element of the magnetic circuit are movable with respect to each other and a mutual position of the first element and the second element is arranged to at least partly determine strength of the magnetic flux that is directed to the brake actuator. Therefore, the braking effect generated by the brake actuator can be adjusted by adjusting the mutual position of the first element and the second element.

In FIG. 7a, the brake actuator and the magnetic circuit are shown as dashed lines in the first part 701. The first part 701 comprises a control arm 703 with the aid of which the mutual position of the first element and the second of the magnetic circuit can be adjusted.

In a hinge mechanism according to an embodiment of the invention the magnetic circuit comprises a bypass magnetic path for a magnetic flux that bypasses the brake actuator. A change in the mutual position of the first element and the second element of the magnetic circuit is arranged to increase strength of the bypassing magnetic flux as a response to a situation in which the above-mentioned change causes a decrease in the strength of the magnetic flux that is directed to the brake actuator.

In a hinge mechanism according to an embodiment of the invention the first element of the magnetic circuit comprises a permanent magnet having a cylindrical shape and a magnetizing direction that is perpendicular to an axis of the cylindrical shape. The strength of the magnetic flux directed to the brake actuator is changed as a response to a situation in which the permanent magnet is rotated around the above-mentioned axis. The permanent magnet can be rotated, for example, with the aid of a coil of electrical conductor arranged to carry an electrical current for producing a magnetic field that tends to rotate the permanent magnet around the axis.

In a hinge mechanism according to an embodiment of the invention the first element of the magnetic circuit comprises a permanent magnet having a cylindrical shape and a magnetizing direction that is parallel with an axis of the cylindrical shape. The strength of the magnetic flux directed to the brake actuator is changed as a response to a situation in which the permanent magnet is moved in a direction of the above-mentioned axis. The permanent magnet can be moved, for example, with the aid of a coil of electrical conductor arranged to carry an electrical current for producing a magnetic field that tends to move the permanent magnet in the direction of the axis.

In a hinge mechanism according to an embodiment of the invention the brake actuator comprises ferrofluid or magnetorheological fluid the viscosity/stiffness of which is responsive to the magnetic flux directed to the brake actuator. The viscosity produces a braking force on a surface of solid material that is in contact with the ferrofluid or the magnetorheological fluid as a response to a situation in which the surface moves with respect to the ferrofluid or the magnetorheological fluid.

In a hinge mechanism according to an embodiment of the invention the brake actuator is a disk brake that comprises a brake disk and a brake pad. The brake pad is pressed against the brake disk as a response to a situation in which a magnetic flux is conducted into the brake actuator.

In a hinge mechanism according to an embodiment of the invention the brake actuator is a drum brake that comprises a brake drum and a brake shoe. The brake shoe is pressed against the brake drum as a response to a situation in which a magnetic flux is conducted into the brake actuator.

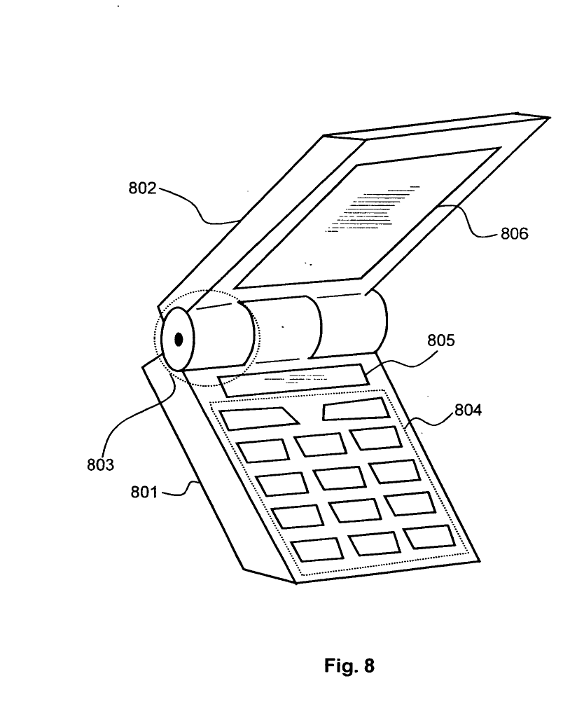

FIG. 8 shows a folding electronic device according to an embodiment of the invention. The folding electronic device has a first part 801 and a second part 802 that are hinged to each other. The folding electronic device comprises a brake actuator arranged to generate a braking force responsive to a magnetic flux directed to the brake actuator. The braking force is able to damp turning movement of the first part with respect to the second part. The folding electronic device comprises a magnetic circuit arranged to generate the magnetic flux and to conduct the magnetic flux to the brake actuator. A first element of the magnetic circuit is movable with respect to a second element of the magnetic circuit and a mutual position of the first element and the second element is arranged to at least partly determine strength of the magnetic flux directed to the brake actuator. Therefore, the braking effect generated by the brake actuator can be adjusted by adjusting the mutual position of the first element and the second element. In the folding electronic device shown in FIG. 8, the brake actuator and the magnetic circuit can be located in the part pointed out with a dashed line circle 803.

In a folding electronic device according to an embodiment of the invention the magnetic circuit comprises a bypass magnetic path for a magnetic flux that bypasses the brake actuator. A change in the mutual position of the first element and the second element of the magnetic circuit is arranged to increase strength of the bypassing magnetic flux as a response to a situation in which the above-mentioned change causes a decrease in the strength of the magnetic flux that is directed to the brake actuator.

A folding electronic device according to an embodiment of the invention is a folding mobile phone.

A folding electronic device according to an embodiment of the invention is a folding handheld computer, i.e. a folding palmtop computer.

A folding electronic device according to an embodiment of the invention is a folding portable computer, i.e. a folding laptop computer.

In a folding electronic device according to an embodiment of the invention the second part 802 is a flip cover that is arranged to cover, in a situation in which the folding electronic device is in a closed position, at least a part of at least one of the following: a keyboard 804 and a display screen 805.

In a folding electronic device according to an embodiment of the invention the first part 801 comprises a keyboard 804 and the second part 802 comprises a display screen 806.

In a folding electronic device according to an embodiment of the invention a route of an electrical cable between the first part 801 and the second part 802 is arranged to go through a hollow brake wheel of the brake actuator in a similar manner as the route of the cable in the adjustable brake device shown in FIGS. 1f and 1g.

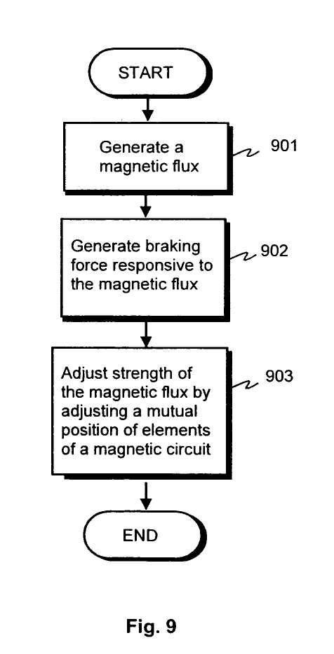

FIG. 9 is a flow chart of a method according to an embodiment of the invention for adjusting damping of turning movement of hinged parts of a folding electronic device. In the method: a magnetic flux is generated 901, a braking force able to damp the turning movement and responsive to the magnetic flux is generated 902, and strength of the magnetic flux is adjusted 903 by adjusting a mutual position of a first element and a second element of a magnetic circuit.

In a method according to an embodiment of the invention decreasing of the strength of the above-mentioned magnetic flux by adjusting the mutual position of said first element and said second element causes an increase in strength of another magnetic flux.

In a method according to an embodiment of the invention the magnetic flux is generated with a permanent magnet having a cylindrical shape and a magnetizing direction perpendicular to an axis of the cylindrical shape. Rotating the permanent magnet around the above-mentioned axis changes the strength of the magnetic flux. The permanent magnet can be rotated, for example, with the aid of a coil of electrical conductor arranged to carry an electrical current for producing a magnetic field that tends to rotate the permanent magnet around the axis.

In a method according to an embodiment of the invention the magnetic flux is generated with a permanent magnet having a cylindrical shape and a magnetizing direction parallel with an axis of the cylindrical shape. Moving the permanent magnet in the direction of the above-mentioned axis changes the strength of the magnetic flux. The permanent magnet can be moved, for example, with the aid of a coil of electrical conductor arranged to carry an electrical current for producing a magnetic field that tends to move the first element in the direction of the axis.

In a method according to an embodiment of the invention ferrofluid or magnetorheological fluid is used for generating the braking force that is able to damp turning movement of the hinged parts of the folding electronic device. The viscosity/stiffness of the ferrofluid or the magnetorheological fluid is responsive to the magnetic flux. The viscosity produces the braking force on a surface of solid material that is in contact with the ferrofluid or the magnetorheological fluid as a response to a situation in which the surface moves with respect to the ferrofluid or the magnetorheological fluid.

In a method according to an embodiment of the invention a disk brake is used for generating the braking force that is able to damp turning movement of the hinged parts of the folding electronic device. The disk brake comprises a brake disk and a brake pad. The brake pad is pressed against the brake disk as a response to a situation in which a magnetic flux is conducted into the brake pad.

In a method according to an embodiment of the invention a drum brake is used for generating the braking force that is able to damp turning movement of the hinged parts of the folding electronic device. The drum brake comprises a brake drum and a brake shoe. The brake shoe is pressed against the brake drum as a response to a situation in which a magnetic flux is conducted into the brake shoe.

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the independent claims appended hereto. The specific examples provided in the description given above should not be construed as limiting. Therefore, the invention is not limited merely to the embodiments described above, many variants being possible without departing from the scope of the inventive idea defined in the independent claims.

What is claimed is:

1. An adjustable brake device, comprising:
a brake actuator arranged to generate a braking force responsive to a magnetic flux directed to said brake actuator, and
a magnetic circuit arranged to generate said magnetic flux and arranged to conduct said magnetic flux to said brake actuator,
wherein a first element of said magnetic circuit is movable with respect to a second element of said magnetic circuit and a mutual position of said first element and said second element is arranged to at least partly determine strength of said magnetic flux.

2. An adjustable brake device according to claim 1, wherein said magnetic circuit comprises a bypass magnetic path arranged to conduct another magnetic flux to bypass said brake actuator, a change in the mutual position of said first element and said second element arranged to increase strength of the other magnetic flux as a response to a situation in which said change causes a decrease in the strength of said magnetic flux directed to said brake actuator.

3. An adjustable brake device according to claim 1, wherein said magnetic circuit comprises a coil of electrical conductor capable of carrying magnetizing electrical current for generating said magnetic flux.

4. An adjustable brake device according to claim 1, wherein said first element of said magnetic circuit comprises a permanent magnet having a cylindrical shape and a magnetizing direction perpendicular to an axis of said cylindrical shape, the strength of said magnetic flux arranged to be changed as a response to a situation in which said permanent magnet is rotated around said axis.

5. An adjustable brake device according to claim 4, comprising a coil of electrical conductor arranged to carry an electrical current for producing a magnetic field that tends to rotate said permanent magnet around said axis.

6. An adjustable brake device according to claim 1, wherein said first element of said magnetic circuit comprises a permanent magnet having a cylindrical shape and a magnetizing direction parallel with an axis of said cylindrical shape, the strength of said magnetic flux arranged to be changed as a response to a situation in which said permanent magnet is moved in a direction of said axis.

7. An adjustable brake device according to claim 6, comprising a coil of electrical conductor arranged to carry an electrical current for producing a magnetic field that tends to move said first element in the direction of said axis.

8. An adjustable brake device according to claim 1, wherein said brake actuator comprises ferrofluid having viscosity responsive to the magnetic flux directed to said brake actuator, said viscosity being arranged to produce the braking force on a surface of solid material in contact with said ferrofluid as a response to a situation in which said surface moves with respect to said ferrofluid.

9. An adjustable brake device according to claim 1, wherein said brake actuator comprises magnetorheological fluid having viscosity responsive to the magnetic flux directed to said brake actuator, said viscosity being arranged to produce the braking force on a surface of solid material in contact with said magnetorheological fluid as a response to a situation in which said surface moves with respect to said magnetorheological fluid.

10. An adjustable brake device according to claim 1, wherein said brake actuator comprises a brake disk and a brake pad arranged to be pressed against said brake disk as a response to a situation in which said magnetic flux is conducted into said brake actuator.

11. An adjustable brake device according to claim 1, wherein said brake actuator comprises a brake drum and a brake shoe arranged to be pressed against said brake drum as a response to a situation in which said magnetic flux is conducted into said brake actuator.

12. A hinge mechanism, comprising:
a first part and a second part that are able to turn with respect to each other,
a brake actuator arranged to generate a braking force responsive to a magnetic flux directed to said brake actuator, said braking force being able to damp turning movement of said first part with respect to said second part, and
a magnetic circuit arranged to generate said magnetic flux and arranged to conduct said magnetic flux to said brake actuator,
wherein a first element of said magnetic circuit is movable with respect to a second element of said magnetic circuit and a mutual position of said first element and said second element is arranged to at least partly determine strength of said magnetic flux.

13. A hinge mechanism according to claim 12, wherein said magnetic circuit comprises a bypass magnetic path arranged to conduct another magnetic flux to bypass said brake actuator, a change in the mutual position of said first element and said second element arranged to increase strength of the other magnetic flux as a response to a situation in which said change causes a decrease in the strength of said magnetic flux directed to said brake actuator.

14. A hinge mechanism according to claim 12, wherein said first element of said magnetic circuit comprises a permanent magnet having a cylindrical shape and a magnetizing direction perpendicular to an axis of said cylindrical shape, the strength of said magnetic flux arranged to be changed as a response to a situation in which said permanent magnet is rotated around said axis.

15. A hinge mechanism according to claim 14 comprising a coil of electrical conductor arranged to carry an electrical current for producing a magnetic field that tends to rotate said permanent magnet around said axis.

16. A hinge mechanism according to claim 12, wherein said first element of said magnetic circuit comprises a permanent magnet having a cylindrical shape and a magnetizing direction parallel with an axis of said cylindrical shape, the strength of said magnetic flux being arranged to be changed as a response to a situation in which said permanent magnet is moved in a direction of said axis.

17. A hinge mechanism according to claim 16, comprising a coil of electrical conductor arranged to carry an electrical current for producing a magnetic field that tends to move said first element in the direction of said axis.

18. A hinge mechanism according to claim 12, wherein said brake actuator comprises ferrofluid having viscosity responsive to the magnetic flux directed to said brake actuator, said viscosity arranged to produce the braking force on a surface of solid material in contact with said ferrofluid as a response to a situation in which said surface moves with respect to said ferrofluid.

19. A hinge mechanism according to claim 12, wherein said brake actuator comprises magnetorheological fluid (MRF) having viscosity responsive to the magnetic flux directed to said brake actuator, said viscosity arranged to produce the braking force on a surface of solid material that is in contact with said magnetorheological fluid as a response to a situation in which said surface moves with respect to said magnetorheological fluid.

20. A hinge mechanism according to claim 12, wherein said brake actuator comprises a brake disk and a brake pad arranged to be pressed against said brake disk as a response to a situation in which said magnetic flux is conducted into said brake pad.

21. A hinge mechanism according to claim 12, wherein said brake actuator comprises a brake drum and a brake shoe arranged to be pressed against said brake drum as a response to a situation in which said magnetic flux is conducted into said brake shoe.

22. A folding electronic device having a first part and a second part that are hinged to each other, the folding electronic device comprising:
a brake actuator arranged to generate a braking force responsive to a magnetic flux directed to said brake actuator, said braking force being able to damp turning movement of the first part with respect to the second part, and
a magnetic circuit arranged to generate said magnetic flux and arranged to conduct said magnetic flux to said brake actuator, wherein a first element of said magnetic circuit is movable with respect to a second element of said magnetic circuit and a mutual position of said first element and said second element is arranged to at least partly determine strength of said magnetic flux.

23. A folding electronic device according to claim 22, wherein said magnetic circuit comprises a bypass magnetic path arranged to conduct another magnetic flux to bypass said brake actuator, a change in the mutual position of said first element and said second element arranged to increase strength of the other magnetic flux as a response to a situation in which said change causes a decrease in the strength of said magnetic flux directed to said brake actuator.

24. A folding electronic device according to claim 22, wherein said folding electronic device is one of the following: a folding mobile phone, a folding handheld computer, and a folding portable computer.

25. A folding electronic device according to claim 22, wherein the second part is a flip cover that is arranged to cover, in a situation in which the folding electronic device is in a closed position, at least a part of at least one of the following: a keyboard and a display screen.

26. A folding electronic device according to claim 22, wherein the first part comprises a keyboard and the second part comprises a display screen.

27. A folding electronic device according to claim 22, wherein a route of an electrical cable between the first part and the second part is arranged to go through a hollow brake wheel of said brake actuator.

28. A method for adjusting damping of turning movement of hinged parts of a folding electronic device, the method comprising:
generating a magnetic flux,
generating a braking force responsive to said magnetic flux, said braking force being able to damp turning movement of the hinged parts of the folding electronic device, and
adjusting strength of said magnetic flux by adjusting a mutual position of a first element and a second element of a magnetic circuit.

29. A method according to claim 28, wherein decreasing of the strength of said magnetic flux by adjusting the mutual position of said first element and said second element causes an increase in strength of another magnetic flux.

30. A method according to claim 28, wherein said magnetic flux is generated with a permanent magnet having a cylindrical shape and a magnetizing direction perpendicular to an axis of said cylindrical shape and the strength of said magnetic flux is changed by rotating said permanent magnet around said axis.

31. A method according to claim 30, wherein said permanent magnet is rotated around said axis by using a coil of electrical conductor carrying an electrical current for producing a magnetic field that tends to rotate said permanent magnet around said axis.

32. A method according to claim 28, wherein said magnetic flux is generated with a permanent magnet having a cylindrical shape and a magnetizing direction parallel with an axis of said cylindrical shape and the strength of said magnetic flux is changed by moving said permanent magnet in a direction of said axis.

33. A method according to claim 32, wherein said permanent magnet is moved in the direction of said axis by using a coil of electrical conductor carrying an electrical current for producing a magnetic field that tends to move said first element in the direction of said axis.

34. A method according to claim 28, wherein the braking force is generated by using ferrofluid having viscosity responsive to said magnetic flux, said viscosity producing the braking force on a surface of solid material in contact with said ferrofluid as a response to a situation in which said surface moves with respect to said ferrofluid.

35. A method according to claim 28, wherein the braking force is generated by using magnetorheological fluid having viscosity responsive to said magnetic flux, said viscosity producing the braking force on a surface of solid material in contact with said magnetorheological fluid as a response to a situation in which said surface moves with respect to said magnetorheological fluid.

36. A method according to claim 28 wherein the braking force is generated by using a disk brake that comprises a brake disk and a brake pad that is pressed against said brake disk as a response to a situation in which said magnetic flux is conducted into said brake pad.

37. A method according to claim 28, wherein the braking force is generated by using a drum brake that comprises a brake drum and a brake shoe that is pressed against said brake drum as a response to a situation in which said magnetic flux is conducted into said brake shoe.
